(19) United States
(12) Patent Application Publication
(10) Pub. No.: US 2009/0317057 A1
(43) Pub. Date: Dec. 24, 2009

(54) APPARATUS AND METHOD FOR SELECTIVELY OUTPUTTING HD/SD SIGNALS AS HIGH DEFINITION VIDEO ACCORDING TO COPY PROTECTION

(76) Inventors: Hua Wu, Hsinchu County (TW); Te-Chi Hsiao, Hsinchu City (TW); Hau-Jean Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/144,637

(22) Filed: Jun. 24, 2008

(51) Int. Cl. H04N 5/91

(52) U.S. Cl. 386/94; 386/E05.003

(57) ABSTRACT

An apparatus for outputting standard definition (SD) and high-definition (HD) analog signals as high-definition (HD) video according to copy protection is disclosed. The apparatus includes: a determination block, for receiving a specific signal and determining whether the received specific signal has copy protection; and a scaling block, coupled to the determination block, for selectively scaling the received specific signal according to at least a copy protection determination result generated by the determination block.

### BACKGROUND

This invention relates to high-definition video processing, and more particularly to outputting a received signal as a high-definition signal according to copy protection.

Recent developments in technology have given rise to high-definition (HD) video, and HD displays. HD video comprises more scan lines and pixels than traditional standard definition (SD) video, providing sharper displays and improved visuals. A current HD display includes a digital and an analog input that receives a multimedia signal for outputting. A user can determine to output the received signal as an SD signal or as an HD signal, wherein the received signal may have to be upscaled to fit the required definition format.

If the multimedia signal is copy protected, when the signal is output to the HD display some encryption will need to be provided, to ensure the output data is protected. At present, although digital HD data can be encrypted to fit with desired specifications, no such scheme exists for analog HD data. Current HD displays will simply output the HD data without first encrypting it. Furthermore, the displays will upscale copy protected SD data and output it as HD data without first encrypting it. As user can therefore record the output data, thereby infringing the data provider's legal rights.

### SUMMARY

It is therefore an objective of the present invention to provide an apparatus and method for selectively outputting SD and HD signals as HD video according to copy protection.

An apparatus for outputting standard definition (SD) and high-definition (HD) analog signals as high-definition (HD) video according to copy protection is disclosed. The apparatus comprises: a determination block, for receiving a specific signal and determining whether the received specific signal has copy protection; and a scaling block, coupled to the determination block, for selectively scaling the received specific signal according to at least a copy protection determination result generated by the determination block.

A method is further disclosed. The method comprises: receiving a signal; determining if the received signal is an HD or an SD signal; determining whether the received signal has copyright protection; selectively scaling the received signal according to the detection result; and outputting the signal; wherein if it is determined that the received signal has copyright protection, the signal will not be output as an HD signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an analog rendering device according to an embodiment of the present invention.

FIG. 2 is a diagram showing the available signal processing paths of the analog rendering device in FIG. 1.

FIG. 3 is a diagram of an analog rendering device according to another embodiment of the present invention.

FIG. 4 is a diagram showing the available signal processing paths of the analog rendering device in FIG. 3.

### DETAILED DESCRIPTION

A first objective of the present invention is to provide a system that prevents copy protected data from being output without an appropriate encryption scheme.

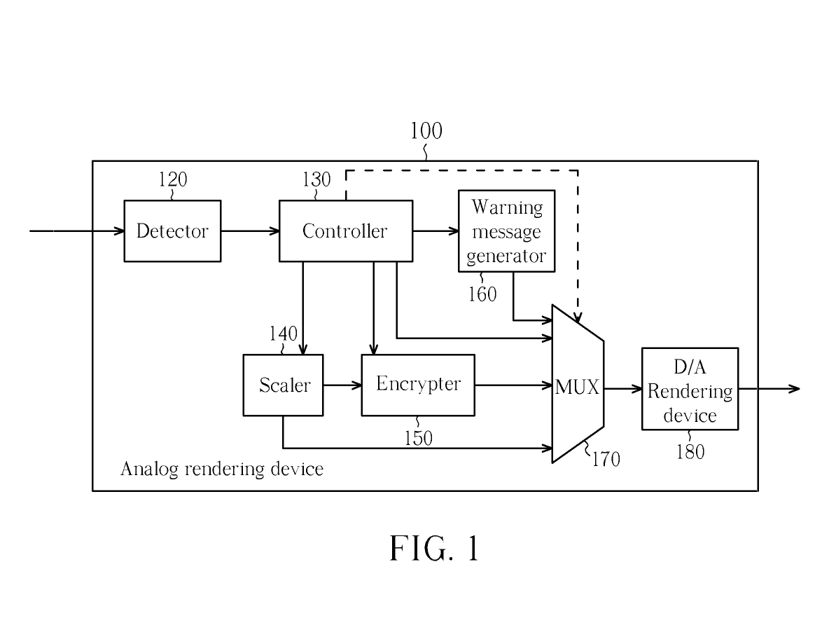

Please refer to FIG. 1. FIG. 1 is a diagram of an analog rendering device 100 according to an embodiment of the present invention. The analog rendering device 100 comprises a detector (i.e. a determination block) 120, a controller 130, a scaler (i.e. a scaling block) 140, an encrypter (i.e. a copyright encoding block) 150, a warning message generator (i.e. a generating block) 160, a multiplexer (MUX) 170, and a D/A rendering device 180. Please note that the scaler 140 in the analog rendering device 100 can either upscale or downscale a received signal, according to a determination result from the detector 120. The encrypter 150 is designed to add MacroVision or VBID copyright protection encryption. In this embodiment, the analog rendering device 100 is coupled between a decoder and an analog terminal of an analog apparatus. For instance, the analog rendering device 100 is disposed in an optical storage player (e.g. a DVD player) and used for rendering a video output to a display device (e.g. a television system) according to incoming video data generated from the decoder decoding read-back signals read from an optical storage medium (e.g. a DVD). However, this is not meant to be a limitation of the present invention. Additionally, only the components pertinent to the present invention are shown.

When a signal is received by the analog rendering device 100, the signal is sent to the detector 120, which first determines whether the signal is an SD or an HD signal. The detector 120 further determines whether the received signal is copy protected. The controller 130 then determines the path the signal will take. If the signal is not copy protected, then the operation can proceed as in the prior art. An HD signal that is not copy protected will be directly output to the MUX 170 of the analog rendering device 100; an SD signal that is not copy protected will first be sent to the scaler 140 for being upscaled to an HD format, and then output to the MUX 170, then the D/A rendering device 180 for digital-to-analog conversion. In other words, according to the detection result given by the detector 120, the controller 130 controls the MUX 170 to allow the desired signal to be output.

When an SD signal is received by the analog rendering device 100 and the detector 120 determines that the signal is copy protected, the signal will not be output to the scaler 140. The controller 130 either determines to directly send the signal to the encrypter 150, for adding SD copyright protection to the received signal; or the controller 130 will send a signal to the warning message generator 160. The warning message generator 160 is for generating and displaying a message to the user, informing the user of the copy protection status of the received signal. If the optical storage player also includes a digital rendering device, the generated message could be for instructing the user to connect the digital input of a television system to the optical storage player for receiving digital video output. If the optical storage player only includes the analog rendering device 100, the generated message could be for informing the user to select to output the received signal in an SD format. In another embodiment, the controller 130 can determine to automatically output the received signal as an SD signal. In such a case the analog rendering device 100 will not include the aforementioned warning message generator 160. In other words, the warning message generator 160 would be optional for some embodiments of the present invention.

When an HD signal is received by the analog rendering device 100 and the detector 120 determines that the signal is copy protected, the analog rendering device 100 will not output the signal as an HD signal. In an embodiment wherein the analog rendering device 100 includes the warning message generator 160, the detector 120 can inform the controller 130 to control the warning message generator 160 to generate a message on receipt of an HD signal that is copy protected. If the optical storage player includes a digital rendering device, the message generated by the warning message generator 160 is for instructing a user to connect the digital input of the television system to the optical storage player for receiving digital video output. If the optical storage player does not include a digital rendering device, the generated message is for informing a user that, although the received signal is in an HD format, the signal cannot be displayed in an HD format. In such a case, the controller 130 will send the received HD signal to the scaler 140, where it will be downscaled to an SD format. Once the signal is downscaled, SD copyright protection encoding can be added by the encrypter 150. The downscaled signal will then be sent to the MUX 170, then the D/A rendering device 180 for digital-to-analog conversion.

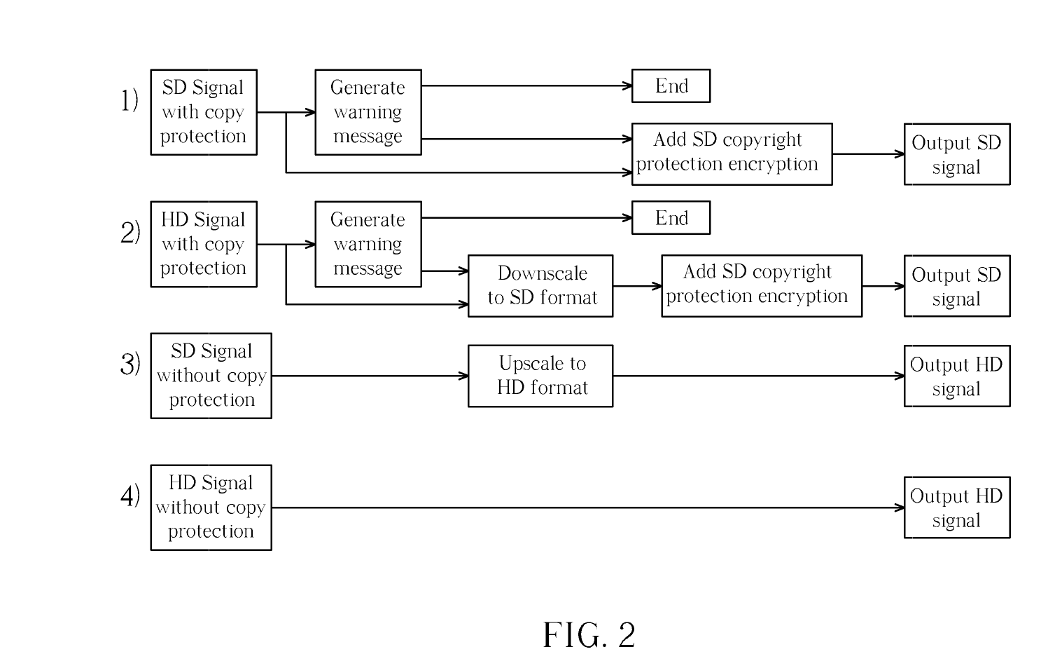

In order to comprehend the operation of the analog rendering device 100 more clearly please refer to FIG. 2. FIG. 2 is a diagram showing the available signal processing paths of the analog rendering device 100 in FIG. 1. As can be seen from the diagram, there are four possible options:
1) The analog rendering device 100 receives an SD signal with copy protection.
2) The analog rendering device 100 receives an HD signal with copy protection.
3) The analog rendering device 100 receives an SD signal without copy protection.
4) The analog rendering device 100 receives an HD signal without copy protection.

In all four cases the signal will be sent to the detector 120 for determining the format of the signal, and the copy protection status. In case 4) the signal will be directly sent to the MUX 170, then the D/A rendering device 180. In case 3) the signal will first be sent to the scaler 140 for being upscaled to an HD format, then sent to the MUX 170, then the D/A rendering device 180. Please note that these cases are the same as in the related art.

In case 1) the analog rendering device 100 can automatically send the received signal to the encrypter 140, for adding SD copyright protection encryption. Alternatively, the analog rendering device 100 can send a signal to the warning message generator 160, for generating a warning message to the user. If the user chooses to view the signal in an SD format the signal will then be sent to the encrypter 140.

In case 2) the analog rendering device 100 will either send a signal to the warning message generator 160, for generating a warning message to the user as above, or send the received signal to the scaler 140. The signal will then be downscaled to an SD format, sent to the encrypter 150, for adding SD copyright protection encryption, then sent to the MUX 170. Please note that, on reception of the warning message, the user can similarly choose to view the signal in an SD format.

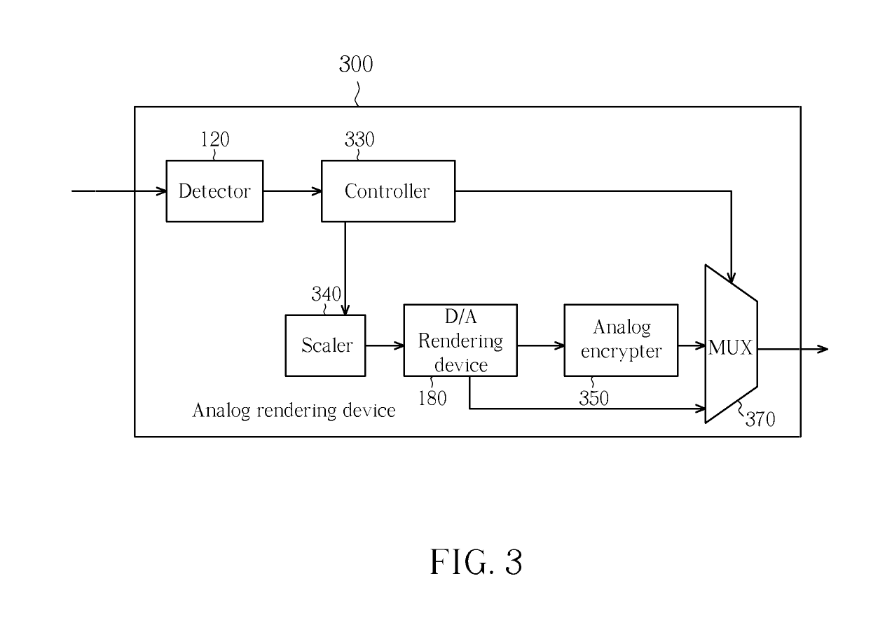

Please refer to FIG. 3. FIG. 3 is a diagram of an analog rendering device 300 according to another embodiment of the present invention. Please note that some blocks have the same function as in FIG. 1 and have thus been given the same numeral for simplicity. The analog rendering device 300 comprises a detector (i.e. a determination block) 120, a scaler (i.e. a scaling block) 340, a controller 330, a D/A rendering device 180, an analog encrypter (i.e. a copyright encoding block) 350, and a multiplexer (MUX) 370. Please note the scaler 340 only needs to have upscaling functionality as this embodiment enables all signals to be output in an HD format. Similarly, the encrypter 350 only requires HD encryption functionality. Furthermore, this embodiment does not require the warning message generator 160.

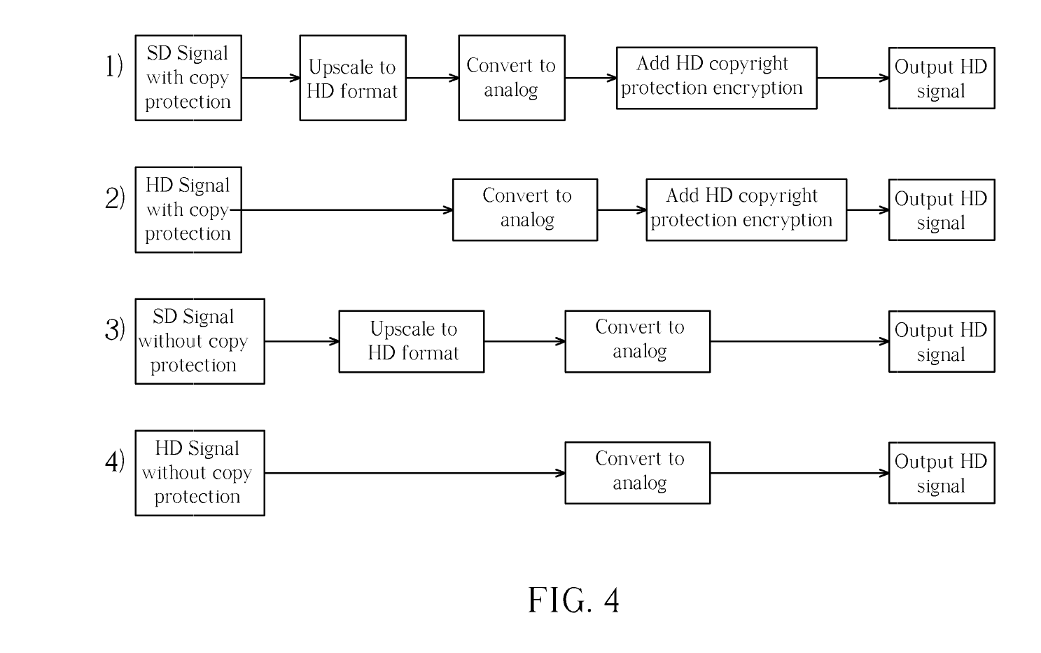

In order to comprehend the operation of the analog rendering device 300 more clearly please refer to FIG. 4. FIG. 4 is a diagram showing the available signal processing paths of the analog rendering device 300 in FIG. 3. The operation of the embodiment shown in FIG. 3 will now be described with reference to the previously mentioned four cases:
1) The analog rendering device 300 receives an SD signal with copy protection.
2) The analog rendering device 300 receives an HD signal with copy protection.
3) The analog rendering device 300 receives an SD signal without copy protection.
4) The analog rendering device 300 receives an HD signal without copy protection.

In case 1) the signal will first be sent to the scaler 340 for upscaling to an HD format, then sent to the D/A rendering device 180, and finally sent to the encrypter 350 for being encrypted with HD copyright protection encryption.

In case 2) the signal will directly be sent to the D/A rendering device 180 and then sent to the encrypter 350 for being encrypted with HD copyright protection encryption.

In case 3) the signal will be sent to the scaler 340 for upscaling to an HD format, then sent to the D/A rendering device 180, and then outputted directly to the MUX 370.

In case 4) the signal will be sent directly to the D/A rendering device 180 and then outputted to the MUX 370.

The disclosed analog rendering devices 100, 300 can prevent signals that require copy protection from being output illegally, by determining the copy protection status of a signal and performing appropriate operations on the signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for outputting standard definition (SD) and high-definition (HD) analog signals as high-definition (HD) video according to copy protection, the apparatus comprising:
a determination block, for receiving a specific signal and determining whether the received specific signal has copy protection; and
a scaling block, coupled to the determination block, for selectively scaling the received specific signal according to at least a copy protection determination result generated by the determination block.

2. The apparatus of claim 1, wherein if the determination block determines that the received specific signal has copy protection, the received specific signal will not be output in an HD format.

3. The apparatus of claim 2, further comprising:
a generating block, coupled to the determination block, wherein if the received specific signal has copy protection, the generating block will generate a message stating that the received specific signal cannot be output in the HD format.

4. The apparatus of claim 2, wherein the determination block further determines whether the received specific signal is an HD signal or an SD signal, and the scaling block selectively scales the received specific signal according to the copy protection determination result and a signal format determination result generated by the determination block.

5. The apparatus of claim 4, wherein if the determination block determines that the received specific signal is an HD signal with copy protection, the scaling block downscales the received specific signal to generate a downscaled signal in an SD format.

6. The apparatus of claim 5, further comprising:
a copyright encoding block, coupled to the scaling block, for adding copyright protection encoding to the downscaled signal.

7. The apparatus of claim 6, wherein the copyright encoding block adds MacroVision or VBID copyright protection encoding to the downscaled signal.

8. The apparatus of claim 4, wherein if the determination block determines that the received specific signal is an SD signal without copy protection, the scaling block upscales the received specific signal to generate an upscaled signal in the HD format.

9. The apparatus of claim 4, wherein if the determination block determines that the received specific signal is an HD signal without copy protection, the determination block directly outputs the received specific signal without sending the received specific signal to the scaling block.

10. The apparatus of claim 4, further comprising a
a copyright encoding block, coupled to the determination block, for adding copyright protection encoding;
wherein if the determination block determines that the received specific signal is an SD signal with copy protection, the determination block directly outputs the received specific signal to the copyright encoding block.

11. The apparatus of claim 10, wherein the copyright encoding block adds MacroVision or VBID copyright protection encoding to the received specific signal.

12. An apparatus for outputting standard definition (SD) and high-definition (HD) analog signals as high-definition (HD) video, the apparatus comprising:
a determination block, for receiving a specific signal and determining whether the received specific signal has copy protection; and
a copyright encoding block, coupled to the determination block, for selectively adding copyright protection encoding to an incoming signal in an HD format according to a copy protection determination result generated by the determination block.

13. The apparatus of claim 12, wherein the determination block further determines whether the received specific signal is an HD signal or an SD signal, and the determination block directly outputs the received specific signal as the incoming signal if it determines that the received specific signal is an HD signal.

14. The apparatus of claim 12, wherein the determination block further determines whether the received specific signal is an HD signal or an SD signal, and the apparatus further comprises a scaling block, coupled to the determination block and the copyright encoding block, for upscaling the received specific signal to generate the incoming signal if the determination block determines that the received specific signal is an SD signal.

15. A method for outputting standard definition (SD) and high-definition (HD) analog signals as high-definition (HD) video according to copy protection, the method comprising:
receiving a signal;
determining a copy protection result of the received specific signal;
selectively scaling the received specific signal according to at least the copy protection result; and
outputting the received specific signal.

16. The method of claim 15, wherein if the step of determining the copy protection result of the received specific signal determines that the received specific signal has copy protection, the received specific signal will not be output in an HD format.

17. The method of claim 16, wherein the step of determining the copy protection result of the received specific signal further comprises:
generating a message stating that the received specific signal cannot be output in the HD format.

18. The method of claim 16, wherein the step of receiving the signal further comprises:
determining a signal format determination result of the received specific signal;
and the step of selectively scaling the received specific signal according to at least the copy protection result further comprises:
selectively scaling the received specific signal according to the copy protection determination result and the signal format determination result.

19. The method of claim 18, wherein if the received specific signal is an SD signal with copy protection, the step of selectively scaling the received specific signal according to the copy protection determination result and the signal format determination result further comprises: downscaling the received specific signal to generate a downscaled signal in an SD format.

20. The method of claim 19, further comprising:
adding copyright protection encryption to the downscaled signal.

21. The method of claim 20, wherein the copyright protection encryption is MacroVision or VBID copyright protection encryption.

22. The method of claim 18, wherein if the received specific signal is an SD signal without copy protection, the step of selectively scaling the received specific signal according to the copy protection determination result and the signal format determination result further comprises:
upscaling the received specific signal to generate an upscaled signal in an HD format.

23. The method of claim 18, wherein if the received specific signal is an HD signal without copy protection, the step of selectively scaling the received specific signal according to the copy protection determination result and the signal format determination result further comprises:
directly outputting the received specific signal in an HD format.

24. The method of claim 18, wherein if the received specific signal is an SD signal with copy protection, the step of selectively scaling the received specific signal according to the copy protection determination result and the signal format determination result further comprises:
adding copyright protection encryption to the received specific signal.

25. The method of claim 24, wherein the copyright protection encryption is MacroVision or VBID copyright protection encryption.

26. A method for outputting standard definition (SD) and high-definition (HD) analog signals as high-definition (HD) video, the method comprising:
receiving a specific signal;
determining whether the received specific signal has copy protection to generate a copy protection determination result;
outputting the received specific signal as a specific signal in an HD format; and
selectively adding copy protection encryption to the specific signal according to the copy protection determination result.

27. The method of claim 26, wherein the step of receiving the specific signal further comprises:
determining whether the received specific signal is an HD or an SD signal;
wherein if the signal is an HD signal, the step of outputting the received specific signal as a specific signal in an HD format further comprises:
directly outputting the received specific signal as the specific signal.

28. The method of claim 26, wherein the step of receiving the specific signal further comprises:
determining whether the received specific signal is an HD or an SD signal;
wherein if the signal is an SD signal, the step of outputting the received specific signal as a specific signal in an HD format further comprises:
scaling the received specific signal to generate the specific signal.
